(19) United States
(12) Patent Application Publication
(10) Pub. No.: US 2005/0248508 A1
(43) Pub. Date: Nov. 10, 2005

(54) Display apparatus

(76) Inventors: Hwa-seok Seong, Suwon-si (KR); Ho-seop Lee, Seoul (KR); Young-sun Kim, Suwon-si (KR); Jong Sul Min, Hwansoong-si (KR)

Correspondence Address: STANZIONE & KIM, LLP, 919 18TH STREET, N.W., SUITE 440, WASHINGTON, DC, 20006, US

(21) Appl. No.: 11/117,421

(22) Filed: Apr. 29, 2005

(30) Foreign Application Priority Data
May 1, 2004 (KR) 2004-30828
Oct. 26, 2004 (KR) 2004-85957

(51) Int. Cl. G09G 3/28

(52) U.S. Cl. 345/63

(57) ABSTRACT

The present general inventive concept relates to a display apparatus processing a frame for a picture by a plurality of timesharing subfields, comprising a gradation converter to convert a video signal into a moving picture gradation, and the moving picture gradation comprises at least two linear gradation levels including one or more successive non-light emission subfields and one or more successive light emission subfields temporally adjacent to the one or more successive non-light emission subfields, and at least one middle gradation level including one or more discontinuous from the non-light emission subfields and one or more discontinuous light emission subfields and the at least one middle gradation level falling between the at least two linear gradation levels. Thus, the display apparatus can decrease a false contour of a moving picture while at the same time finely displaying the moving picture.

### CROSS-REFERENCE TO RELATED APPLICATIONS

This application claims the benefit of Korean Patent Application Nos. 2004-30828 filed on May 1, 2004 and 2004-85957 filed on Oct. 26, 2004 in the Korean Intellectual Property Office, the disclosures of which are incorporated herein in their entirety by reference.

### BACKGROUND OF THE INVENTION

1. Field of the Invention

The present general inventive concept relates to a display apparatus, and more particularly, to a display apparatus, in which a frame of a picture is processed by a plurality of timesharing subfields.

2. Description of the Related Art

In a display apparatus, such as a plasma display panel (PDP) or a digital mirror device (DMD), which represents a gradation using a timesharing method, a false contour may arise in a moving picture. A false contour refers to a gradation difference between a motion area and an area surrounding the motion area that is visually accumulated and represented as an after image, such as a contour line.

FIG. 1 is a schematic control block diagram illustrating a conventional PDP which can reduce the false contour in a moving picture.

As illustrated in FIG. 1, the PDP comprises an inverse gamma corrector 101, a gradation limiting and error diffusing part 102, a dither circuit 103, a motion detector 104, a selector 105, and a panel controller 106.

The inverse gamma corrector 101 corrects an input video signal according to equation 1 (below) and outputs the corrected video signal. The input video signal has information about respective brightness levels corresponding to red (R), green (G), and blue (B) components of a pixel color. In a case where the input/output brightness level is represented as an integer, brightness information below a predetermined decimal point is determined to be an error.
Y=X^{2.2} [equation 1]
where X is the brightness level of the input video signal, and Y is the brightness level of the output video signal.

The gradation limiting and error diffusing part 102 reflects the error of a given pixel to the brightness of adjacent pixels. That is, the generated error is weighted and added to the brightness of the adjacent pixels, and the error added to the adjacent pixels is reflected to the brightness information input from the inverse gamma corrector 101 to the gradation limiting and error diffusing part 102.

The gradation limiting and error diffusing part 102 controls the output of the inverse gamma corrector 101 to have a gradation suitable to decrease the false contour of the moving picture.

FIG. 2 is a table illustrating various gradations displayable by respective weighted subfields.

Hereinbelow, a configuration of the gradation will be described in more detail with reference to the table of FIG. 2.

One frame is temporally divided into eight subfields sf1 through sf8, and 1, 2, 4, 8, 16, 32, 64 and 128 sustain pulses are weighted to the subfields sf1 to sf8, respectively. Each gradation corresponds to a given pixel and is determined by combination of a light emission state and a non light emission state of the respective subfields. The gradation is represented by a codeword including a series of 1's and 0's, where the 1's represent the light emission state of a respective subfield and the 0's represent the non light emission state of the respective subfield. For example, the gradation [3] is represented as a codeword of ‘11000000’. Here, the gradation is equal to the total number of sustain pulses for emitting light in a PDP or a DMD during one time frame according to the codeword.

In the table of FIG. 2, a “use gradation” is selected to decrease the false contour of the moving picture. Further, a “dither gradation” is used together with the “use gradation” to display a still picture. Also, a “dither value” is an inherent value of the dither gradation, which is equal to a difference between the dither gradation and a nearest use gradation. In other words, the dither value represents the difference between a given dither gradation and the nearest use gradation to the given dither gradation. For example, referring to the table of FIG. 2, a gradation level of 5 (10100000) is a dither gradation having a dither value of 2 (01000000), because the nearest use gradation is either the gradation level of 3 (11000000) or the gradation level of 7 (11100000). Referring to the table of FIG. 2, even though the gradations displayable according to the subfields range from ‘0’ to ‘255’, the gradation limiting and error diffusing part 102 selectively uses only the gradations corresponding to predetermined codewords (e.g., the codewords corresponding to linear gradation levels).

That is, the gradation limiting and error diffusing part 102 limits the output of the inverse gamma corrector 101 to serial gradations (use gradation+dither gradation, respectively) to display the still picture, and all errors are diffused to adjacent pixels.

The dither circuit 103 detects a corresponding dither value when an input gradation is the dither gradation, and the motion detector 104 detects motion in a picture based on the video signal. The detected dither value and the detected motion are transmitted to the selector 105.

The selector 105 directly outputs the input gradation from the dither circuit 103 to the panel controller 106 when the motion detector 104 detects that the video signal includes a still picture. On the other hand, when the motion detector 104 detects that the video signal includes a moving picture, the selector 105 converts the input gradation from the dither circuit 103 into the use gradation to display the moving picture and outputs the use gradation.

For example, if the video signal has a brightness level of [44], the gradation limiting and error diffusing part 102 converts the brightness level [44] into a dither gradation [47], and diffuses an error of [3] to adjacent pixels. When the motion detector 104 detects that the video signal includes the moving picture, the selector 105 controls the dither value to be added to or subtracted from the dither gradation, thereby converting the dither gradation into an adjacent use gradation (i.e., the nearest use gradation). For example, in the case of an even frame, the dither gradation [47] is converted into the nearest use gradation by adding the dither value thereto: [47]+[16]=[63]. In the case of an odd frame, the dither gradation [47] is converted into the nearest use gradation by subtracting the dither value therefrom: [47]−[16]=[32]. Consequently, the dither gradation temporally averages out to the gradation [47], thereby displaying a picture that is close to an original picture.

FIG. 3 is a table illustrating codewords that correspond to gradations to display the moving picture according to temporally divided subfields in a conventional display apparatus.

Referring to FIG. 3, a 1-bit transition linearly arises between the gradation for the moving picture and its nearest use gradation. These linear gradations have an effect of decreasing the false contour of the moving picture. However, when one frame is divided into eight subfields, the linear gradations for the moving picture are limited to nine displayable gradations. Thus, the number of displayable gradations (00000000, 10000000, . . . , 11111111) is limited, so that it is difficult to display the moving picture when the moving picture includes slow motion, because the nearest linear gradation may have a relatively large difference from the input gradation.

### SUMMARY OF THE INVENTION

Accordingly, the present general inventive concept provides a display apparatus, in which a false contour of a moving picture is decreased and at the same time the moving picture is finely displayed.

Additional aspects and advantages of the present general inventive concept will be set forth in part in the description which follows and, in part, will be obvious from the description, or may be learned by practice of the general inventive concept.

The foregoing and/or other aspects and advantages of the present general inventive concept are achieved by providing a display apparatus to process a frame of a picture divided into a plurality of timesharing subfields, comprising: a gradation converter to convert a video signal into a moving picture gradation, and the moving picture gradation comprises at least two linear gradation levels including one or more successive non-light emission subfields and one or more successive light emission subfields, and at least one middle gradation level including one or more discontinuous non-light emission subfields and one or more discontinuous light emission subfields and the at least one middle gradation level falling between the at least two linear gradation levels.

The gradation converter may more frequently convert the video signal into one of the at least two linear gradation levels rather than the at least one middle gradation level.

The display apparatus may further comprise a motion sensor to sense a degree of motion in the video signal, wherein the gradation converter either converts the video signal into a neighboring gradation adjacent to the at least one middle gradation level or a predetermined virtual gradation level having a gradation level between respective ones of the at least one middle gradation level according to the sensed degree of motion, and converts the converted gradation into the moving picture gradation, which is determined to be near the predetermined virtual gradation level.

The moving picture gradation may include a plurality of predetermined middle gradation levels between the neighboring ones of the at least two linear gradation levels.

The moving picture gradation may include one middle gradation level between the neighboring ones of the linear gradation levels.

The gradation converter may be set to determine a predetermined upper gradation level and a predetermined lower gradation level between the two neighboring linear gradation levels adjacent to the at least one middle gradation level, and comprises: a first gradation compensator to convert the video signal having a gradation level between the predetermined upper and lower levels into one of the predetermined upper and lower gradation levels, and a second gradation compensator to convert the predetermined upper and lower gradation levels to which the video signal is converted into one of the neighboring linear gradation levels and the at least one middle gradation level, respectively.

The second gradation compensator may convert the video signal having the gradation level between the predetermined upper gradation level and the linear gradation level adjacent to the predetermined upper gradation level and between the predetermined lower gradation level and the linear gradation level adjacent to the predetermined lower gradation level into one of the neighboring linear gradation levels or one of the at least one middle gradation level.

The gradation converter may convert the gradation level of the video signal using one of a dithering method and an error diffusing method.

The display apparatus may further comprise a moving picture detector to detect whether an input video signal includes a moving picture signal, wherein the gradation converter converts the video signal into the moving picture gradation when the moving picture detector detects that the input video signal includes the moving picture signal.

The foregoing and/or other aspects and advantages of the present general inventive concept are also achieved by providing a display apparatus to process a frame of a picture divided into a plurality of timesharing subfields, comprising: a gradation converter to convert a video signal into a moving picture gradation, wherein the moving picture gradation comprises a gradation including a plurality of sequential subfields successively comprising a plurality of light emission subfields, a non-light emission subfield disposed among the plurality of light emission subfields so that the plurality of light emission subfields is not continuous, and at least one non-light emission subfield disposed after the plurality of light emission subfields.

The display apparatus may further comprise a motion sensor to sense a degree of motion in the video signal, wherein the gradation converter converts the video signal into one of a first neighboring gradation level adjacent to a gradation level of the video signal, a second neighboring gradation level adjacent to the first neighboring gradation and one displayable gradation level away from the gradation level of the video signal, and a third neighboring gradation level adjacent to the second neighboring gradation level and two displayable gradation levels away from the gradation level of the video signal according to the degree of motion sensed by the motion sensor.

The gradation converter may comprise a first gradation compensator to convert the video signal into one of a plurality of virtual gradation levels between the first, second, and third neighboring gradation levels according to the degree of motion sensed by the motion sensor, and a second gradation compensator to convert the converted gradation level from the first gradation compensator into one of the first, second, or, third neighboring gradation levels adjacent to the virtual gradation levels.

The gradation converter may select the neighboring gradation level to which the video signal is converted according to the gradation level of the video signal.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a schematic control block diagram illustrating a conventional PDP which can reduce a false contour in a moving picture;

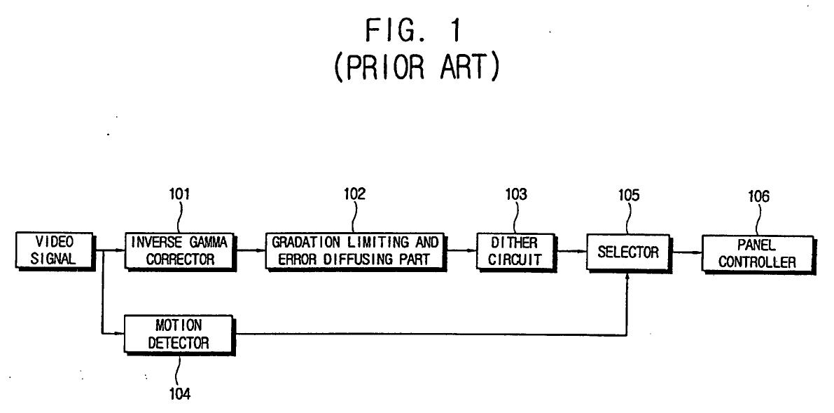

FIG. 2 is a listing various gradations displayable by respective weighted subfields;

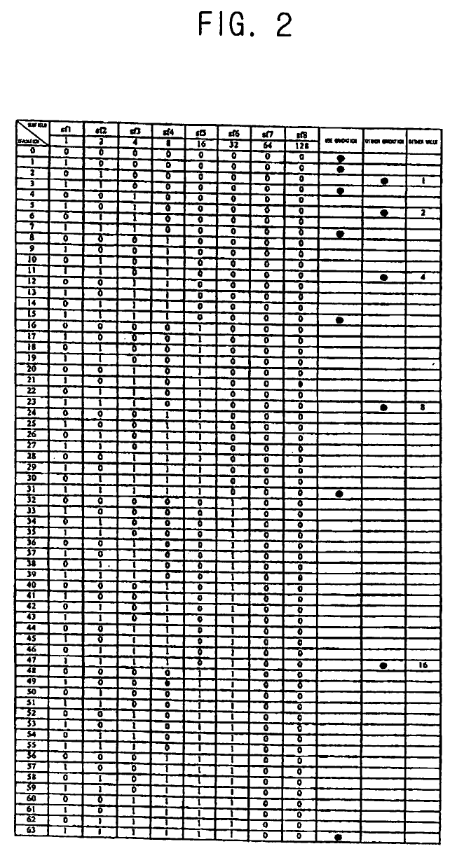

FIG. 3 is a table listing codewords that correspond to gradations to display a moving picture according to temporally divided subfields in a conventional display apparatus;

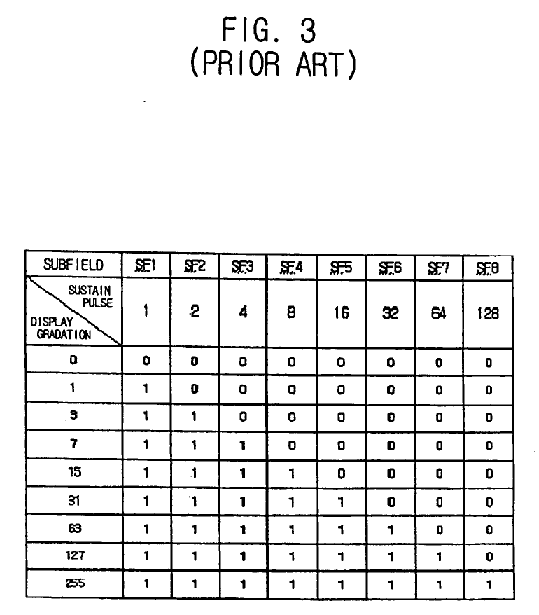

FIG. 4 is a control block diagram illustrating a display apparatus according to an embodiment of the present general inventive concept;

FIG. 5 illustrates a gradation distribution of a method of converting an input gradation according to a dithering method; and

FIG. 6 illustrates a gradation distribution of a method of converting the input gradation including a plurality of middle gradations.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to like elements throughout. The embodiments are described below in order to explain the present general inventive concept by referring to the figures.

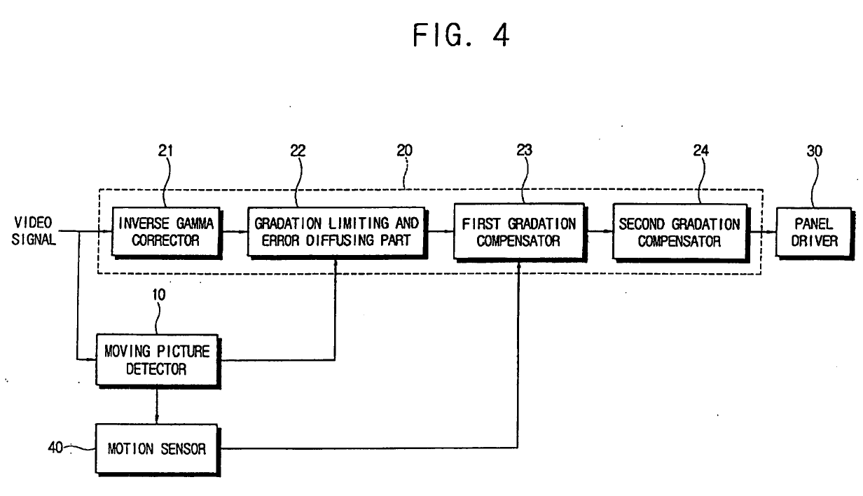

FIG. 4 is a control block diagram illustrating a display apparatus according to an embodiment of the present general inventive concept.

As illustrated in FIG. 4, a display apparatus according to an embodiment of the present general inventive concept comprises a moving picture detector 10, a gradation converter 20, and a panel driver 30.

The moving picture detector 10 detects whether an input video signal includes a moving picture signal. The moving picture detector 10 can detect the moving picture using a motion estimation method of estimating a motion vector between a previous frame and a current frame of a block unit having a predetermined size, a motion detection method of detecting a variance between video pixel values, etc.

The gradation converter 20 either converts the video signal into a moving picture gradation or a still picture gradation according to the detection results of the moving picture detector 10, and outputs the moving picture gradation or the still picture gradation to the panel driver 30 accordingly.

The gradation converter 20 comprises an inverse gamma corrector 21, a gradation limiting and error diffusing part 22, a first gradation compensator 23, and a second gradation compensator 24. The inverse gamma corrector 21 performs gamma correction to the input video signal, and the gradation limiting and error diffusing part 22 diffuses an error generated while the gamma correction is performed. The first gradation compensator 23 and the second gradation compensator 24 will be described below in more detail together with a method of decreasing the false contour.

The panel driver 30 drives a display panel to emit light according to corresponding gradations of pixels on the panel.

Because the gradation converter 20 either converts the input video signal into the moving picture gradation or the still picture gradation according to the detection results of the moving picture detector 10, it is possible to decrease the false contour of the moving picture and at the same time finely represent the gradations of the still picture.

According to an embodiment of the present general inventive concept, the display apparatus further comprises a motion sensor 40 to sense a degree of motion in the input video signal. When the motion sensor 40 senses a fast motion, the gradation converter 20 converts the gradation to largely decrease the false contour. On the other hand, when the motion sensor 40 senses a slow motion, the gradation converter 20 converts the gradation to finely display a picture.

Hereinbelow, a method of finely displaying a moving picture while also decreasing the false contour thereof will be described in more detail according to an embodiment of the present general inventive concept.

According to an embodiment of the present general inventive concept, the moving picture gradation comprises at least one linear gradation level and at least one middle gradation level.

The linear gradation level comprises continuous light emitting subfields and continuous non light emitting subfields. As described above, a codeword of the subfield indicates whether a pixel in each subfield corresponds to a light emission state or a non light emission state. For example, ‘1’ indicates the light emission state, and ‘0’ indicates the non-light emission state. According to an embodiment of the present general inventive concept, there is provided a predetermined number (e.g., twelve) of subfields. The subfields are weighted by increasing the number of sustain pulses from the first subfield to the last subfield. Further, the subfields may be weighted by differently assigning the increase degree of the number of sustain pulses between subfields, as compared with eight subfields. For example, in the case of a total of twelve subfields, a linear gradation level can be represented by a codeword of ‘111100000000.’

The middle gradation level includes a gradation in which subfields in the light-emission state and subfields in the non-light emission state are not grouped together and are discontinuous. In other words, the middle gradation level includes a subfield in the non-light emission state that is adjacent to two sub-fields that are in the light emission state so that the subfields in the light emission state are discontinuous (and vice versa). The middle gradation level falls somewhere between two consecutive linear gradation levels. For example, in the case of twelve total subfields, a middle gradation level can be represented by a codeword of ‘110100000000.’ Thus, this middle gradation level would fall between two neighboring linear gradation levels of ‘111000000000’ and ‘111100000000.’ A middle non-light emission subfield (e.g., the third bit in ‘110100000000’) of the middle gradation level can be freely selected from the light emission subfields as long as it is not adjacent to other non-light emission subfields. The middle gradation level is selected to approximate an arithmetic mean level of neighboring linear gradation levels to represent a fine gradation.

The moving picture gradation according to an embodiment of the present general inventive concept includes a larger number of displayable gradation levels than a number of displayable gradation levels obtained by adding ‘1’ to the number of conventional subfields (e.g., in the case of twelve subfields, twenty four displayable gradation levels are possible), so that a picture can be finely displayed. In other words, adding middle gradation levels between the neighboring linear gradation levels increases the number of displayable gradation levels so that a moving picture gradation can more accurately be approximated. However, by increasing the number of displayable gradation levels, the possibility of a false contour is increased, since a number of times that the video signal is converted into the linear gradation level rather than the middle gradation level is decreased. Thus, the number of times that the video signal is converted into the linear gradation level should be increased in order to effectively decrease the false contour. Adjusting the number of times that the video signal is converted into the linear gradation level can be performed by an error diffusing process, a dithering process, etc.

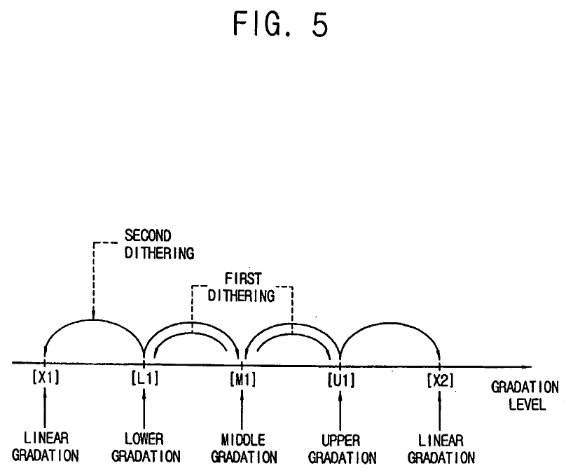

FIG. 5 illustrates a gradation level distribution of a method of converting an input gradation on the basis of a dithering method.

As illustrated in FIG. 5, a middle gradation level [M1] is provided between linear gradation levels [X1] and [X2] (where [X1]<[X2]).

As illustrated in FIG. 5, the gradation converter 20 (see FIG. 4) sets a predetermined upper gradation level [U1] between the middle gradation level [M1] and the linear gradation level [X2], and a predetermined lower gradation level [L1] between the middle gradation level [M1] and the linear gradation level [X1] to perform the dithering process. Here, the predetermined upper gradation level [U1] and the predetermined lower gradation level [L1] are adjusted to approximate an arithmetic mean level of neighboring linear gradation levels.

The gradation converter 20 processes a video signal having a gradation level between the linear gradation levels differently according to the linear, predetermined upper and lower, and middle gradation levels [X1], [X2], [U1], [L1], and [M1], respectively.

First, the gradation converter 20 either converts the video signal into the upper gradation level [U1] or the lower gradation level [L1] when the video signal having the gradation level between the upper gradation level [U1] and the lower gradation level [L1] is input.

The first gradation converter 20 may use the following dynamic dithering method to convert the input gradation level to the upper gradation level or the lower gradation level. The dynamic dithering method converts the input gradation level of the video signal into a neighboring gradation level (i.e., the upper gradation level [U1] or lower gradation level [L1]) by reflecting a relative level between the input gradation level of the video signal and the neighboring gradation level, a weight about a position of the corresponding pixel, or the like. This relation is shown in the following equation 2.
threshold value=S*{(EDx−[L1])}/{([U1]−[L1])}; [equation 2]
where S is a proportional constant, EDx is the input gradation of the video signal, [U1] is the upper gradation level of an upper neighboring gradation level, [L1] is the lower gradation level of a lower neighboring gradation level, and the threshold value is the relative gradation difference between the input gradation level of the video signal and the corresponding neighboring gradation level (i.e., the upper gradation level [U1] or the lower gradation level [L1]). Although the equation 2 refers to [U1] and [L1] as the upper and lower neighboring gradation levels, [U1] and [L1] are merely intended to represent relative neighboring gradation levels, and other neighboring gradation level values can be used to determine a neighboring gradation level to which the input gradation level is to be converted.

Referring to the equation 2, when the EDx is closer to the lower gradation level [L1], the threshold value approaches 0. When the EDx is closer to the upper gradation level [U1], the threshold value approaches S. Thus, the threshold value is a numerical value of the relative gradation difference between the input gradation of the video signal and the corresponding neighboring gradation level. Further, the neighboring gradation level to which the input gradation level of the video signal is to be converted and output is selected according to levels of the threshold value. For example, referring to equation 2, when the threshold value approaches 0 (i.e., EDx is closer to [L1]), the input gradation level EDx of the video signal is converted to the lower gradation level [L1]. Conversely, when the threshold values approaches S (i.e., EDx is closer to [U1]), the input gradation level EDx of the video signal is converted to the upper gradation level [U1]. Alternatively, a weight according to the position of the corresponding pixel may be added to the threshold value, and thus the neighboring gradation level can be selected according to the weighted threshold value.

Referring to FIG. 5, the upper gradation level [U1] and the lower gradation level [L1] are regarded as the upper neighboring gradation level and the lower neighboring gradation level, respectively, and then the dynamic dithering process is applied thereto (hereinafter, referred to as the “first dithering”).

Further, the input gradation level of the video signal that is converted into one of the upper gradation level [U1] and the lower gradation level [L1] is then processed into a final moving picture gradation level by applying the dithering process which provides one of the neighboring linear gradation levels [X2] and [X1] and the middle gradation level [M1] as the upper/lower neighboring gradation level (hereinafter, referred to as the “second dithering”). Thus, the number of times that the input gradation of the video signal is converted into the linear gradation level rather than the middle gradation level is increased.

Only the second dithering is applied to the input gradation of the video signal which does not fall between the upper gradation level and the lower gradation level. In other words, the first dithering is not applied to the video signal having the input gradation level that falls between the upper gradation level [U1] and the linear gradation level [X2] or between the lower gradation level [L1] and the linear gradation level [X1].

According to an embodiment of the present general inventive concept, the moving picture gradation allows a 2-bit transition of the codeword between the neighboring display gradation levels in order to increase the number of display gradations, and at the same time adjusts the corresponding number of times the input gradation level of the video signal is converted to the linear gradation level to decrease the false contour of the moving picture.

According to another embodiment of the present general inventive concept, the moving picture gradation can include a plurality of middle gradation levels.

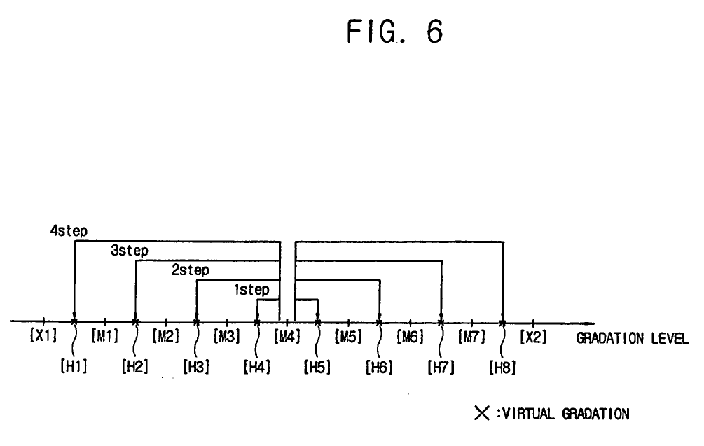

That is, the moving picture gradation level uses the plurality of middle gradation levels as the displayable gradation levels between the linear gradation levels. For example, as illustrated in FIG. 6, seven middle gradation levels [M1] through [M7] can be provided between the linear gradation levels [X1] and [X2]. Alternatively, other numbers of middle gradation levels may also be used.

Thus, the number of displayable gradation levels is increased from the previous embodiment of the present general inventive concept, so that a picture is more finely displayed. Like the previous embodiment, the additional middle gradation levels can have a 2-bit transition with regard to the neighboring gradation levels. In this case, the possibility of the false contour is further increased.

To decrease the false contour, the first and second ditherings may be applied as illustrated in FIG. 5.

First, to apply the first dithering, neighboring upper gradation and neighboring lower gradation levels are set between the middle gradation levels when there are seven middle gradation levels. When the gradation level of the input video signal is provided between the neighboring upper gradation level and the neighboring lower gradation level, the input video signal is either converted into the neighboring upper gradation level or the neighboring lower gradation level by applying the first dithering. Then, the second dithering is performed, thereby converting the converted neighboring upper and lower gradation levels into which the gradation level of the input video signal is converted into one of a neighboring middle gradation level or a neighboring linear gradation level.

As illustrated in FIG. 4, the display apparatus further comprises the motion sensor 40. The motion sensor 40 senses a degree of motion in the moving picture. The degree of motion in the moving picture can be sensed by the detecting method used by the moving picture detector 10, so that a speed of the motion is sensed.

When the motion sensor 40 senses the fast motion, the possibility of the false contour is increased, so that the dithering for the moving picture gradation having the 2-bit transition should be changed.

By way of example, FIG. 6 illustrates the seven middle gradation levels [M1] through [M7] are provided between the linear gradation levels [X1] and [X2], and predetermined virtual gradation levels [H1] through [H8] are provided between the respective gradation levels. The middle gradation level [M1] of FIG. 6 is not equal to the middle gradation level [M1] of FIG. 5.

Each virtual gradation level is used as the neighboring upper gradation level and the neighboring lower gradation level according to the input gradation levels of the video signal. In this case, when the first dithering is applied, the video signal is not converted into one of the actual neighboring upper and lower gradation levels, but is converted into one of the arbitrary virtual gradation levels [H1] to [H8] provided between the linear gradation levels according to the degree of the motion sensed by the motion sensor 40 (see FIG. 4).

For example, if the gradation level [S1] of the input video signal is approximated to a middle gradation level [M4], when the degree of motion detected by the motion detector 40 is determined to be the slow motion, the input gradation level [S1] of video signal is converted into one of the neighboring virtual gradation levels [H4] and [H5] as illustrated with reference to a “1step.” However, when the motion sensor 40 senses that the degree of motion is the fast motion, the input gradation level [S1] of the video signal is converted into one of the virtual gradation levels [H3] and [H6] as illustrated with reference to a “2step.” Further, when the motion sensor 40 senses that the degree of motion is a faster motion, the input gradation level [S1] of the video signal is converted into one of the virtual gradation levels [H2] and [H7] as illustrated with reference to a “3step.” The converted virtual gradation level to which the input gradation level of the video signal is then converted by the second dithering into one of the neighboring middle gradation levels or the neighboring linear gradation level.

Therefore, the false contour can be adjusted according to the degrees of the motion detected in the moving picture. However, when the degree of motion is the fast motion, there is a problem in that a difference between the gradation level of the input video signal and the converted gradation level becomes large. Hence, a relatively large conversion such as the ‘3step’ or a ‘4step’ should not be performed with regard to a visually sensitive dark gradation area. On the other hand, the relatively large conversion may be performed with regard to a bright gradation region. Thus, in order to decrease the false contour when the degree of motion is the fast motion, the number of middle gradation levels between the respective linear gradation levels is limited to a predetermined number or below.

According to an embodiment of the present general inventive concept, when the false contour is adjusted according to the degrees of the motion in the moving picture, various codewords having a 2-bit transition can be used as the moving picture gradation.

According to another embodiment of the present general inventive concept, the moving picture gradation may comprise only the middle gradation level.

In this case, the moving picture gradation level excludes the linear gradation level and uses more displayable gradation levels than the number of displayable gradation levels used in the foregoing embodiments, thereby displaying a picture more finely. Here, because the moving picture gradation does not comprise the linear gradation level, the motion is sensed and the gradation level is varied accordingly.

That is, according to the degrees of the motion, the video signal is converted into either a first neighboring gradation level adjacent to the gradation level of the video signal, a second neighboring gradation level adjacent to the first neighboring gradation level that is one displayable gradation level away from the gradation level of the video signal, a third neighboring gradation level adjacent to the second neighboring gradation level that is two displayable gradation levels away from the gradation level of the video signal, or a fourth neighboring gradation level, and so on. However, like the foregoing embodiments, when the degree of motion is the fast motion, there is a problem in that a large error may arise between the gradation level of the video signal and the neighboring gradation level to which the gradation level of the video signal is converted. Therefore, a difference between the gradation level of the video signal and the neighboring gradation level to which it is converted may be limited with regard to a level visually sensitive for humans according to the gradation level of the video signal.

Similarly, the process of converting the video signal into one of the neighboring levels may be adjusted in the number of times by the first dithering to convert the video signal into virtual upper/lower gradation levels between the respective gradation levels and the second dithering to convert the virtual upper/lower gradation levels to which the video signal is converted into the respective gradation levels.

In the foregoing embodiment, the linear gradation level or the middle gradation level is included by way of example, however other gradation levels may be included. The first gradation compensator 23 and the second gradation compensator 24 illustrated in FIG. 4 are used as blocks to perform the first dithering and the second dithering, respectively.

As described above, the present general inventive concept provides a display apparatus, in which a false contour of a moving picture is decreased and at the same time the moving picture is finely displayed.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A display apparatus processing a frame for a picture by a plurality of timesharing subfields, comprising:
a gradation converter to convert a video signal into a predetermined moving picture gradation, wherein the moving picture gradation comprises a linear gradation including at least one non-light emission subfield successive on at least one successive light emission subfield, and a middle gradation of which one subfield discontinuous from the non-light emission subfield among the light emission subfields of the linear gradation is the non-light emission subfield.

2. The display apparatus according to claim 1, wherein the gradation converter more frequently converts the video signal into one of the at least two linear gradation levels rather than the at least one middle gradation level.

3. The display apparatus according to claim 1, further comprising:
a motion sensor to sense a degree of motion in the video signal,
wherein the gradation converter either converts the video signal into a neighboring gradation adjacent to the at least one middle gradation level or a predetermined virtual gradation level having a gradation level between respective ones of the at least one middle gradation level according to the sensed degree of motion, and the gradation converter further converts the gradation level to which the video signal is converted into one of the moving picture gradation adjacent to the predetermined virtual gradation level.

4. The display apparatus according to claim 1, wherein the moving picture gradation includes a plurality of predetermined middle gradation levels between neighboring ones of the at least two linear gradation levels.

5. The display apparatus according to claim 1, wherein the moving picture gradation includes one middle gradation level between neighboring ones of the at least two linear gradation levels.

6. The display apparatus according to claim 5, wherein the gradation converter is set to determine a predetermined upper gradation level and a predetermined lower gradation level between the two neighboring linear gradation levels adjacent to the at least one middle gradation level, and comprises:
a first gradation compensator to convert the video signal having a gradation level between the predetermined upper and lower gradation levels into one of the predetermined upper and lower gradation levels; and
a second gradation compensator to convert the predetermined upper and lower gradation levels to which the video signal is converted into one of the neighboring linear gradation levels and the at least one middle gradation level, respectively.

7. The display apparatus according to claim 6, wherein the second gradation compensator converts the video signal having a gradation level between the predetermined upper gradation level and the linear gradation level adjacent to the predetermined upper gradation level and a gradation level between the predetermined lower gradation level and the linear gradation level adjacent to the predetermined lower gradation into one of the neighboring linear gradation levels and the at least one middle gradation level.

8. The display apparatus according to claim 3, wherein the gradation converter converts a gradation level of the video signal and the converted gradation level using one of a dithering method and an error diffusing method.

9. The display apparatus according to claim 7, wherein the first gradation compensator and the second gradation compensator convert gradation levels using one of a dithering method and an error diffusing method.

10. The display apparatus according to claim 1, further comprising:
a moving picture detector to detect whether an input video signal includes a moving picture signal, wherein the gradation converter converts the video signal into the moving picture gradation when the moving picture detector detects that the input video signal includes the moving picture signal.

11. A display apparatus processing a frame for a picture by a plurality of timesharing subfields, comprising
a gradation converter to convert a video signal into a predetermined moving picture gradation, wherein the moving picture gradation comprises a gradation including a serial subfields successively comprising a plurality of light emission subfields and one non-light emission subfield, and at least one non-light emission subfield successive to the light emission subfield among the serial subfields.

12. The display apparatus according to claim 11, further comprising:
a motion sensor to sense a degree of motion in the video signal,
wherein the gradation converter converts the video signal into one of a first neighboring gradation adjacent to a gradation level of the video signal, a second neighboring gradation level adjacent to the first neighboring gradation level and one displayable gradation level away from the gradation level of the video signal, and a third neighboring gradation level adjacent to the second neighboring gradation level and two displayable gradation levels away from the gradation level of the video signal according to the degree of motion sensed by the motion sensor.

13. The display apparatus according to claim 12, wherein the gradation converter comprises:
a first gradation compensator to convert the video signal into one of a plurality of virtual levels between the first, second, and third neighboring gradation levels according to the degree of motion sensed by the motion sensor; and
a second gradation compensator to convert the converted gradation level from the first gradation compensator into one of the first, second, and third neighboring gradation levels adjacent to the virtual gradation levels.

14. The display apparatus according to claim 12, wherein the gradation converter selects the neighboring gradation level to which the video signal is converted according to the gradation level of the video signal.

15. The display apparatus according to claim 13, wherein the gradation converter selects the neighboring gradation level to which the video signal is converted according to the gradation level of the video signal.

16. A display apparatus to determine a moving picture gradation for one or more pixels in a frame of a picture temporally divided into a plurality of subfields, comprising:
a gradation converter to receive a video signal and to approximate the moving picture gradation using a plurality of linear gradation levels and at least one middle gradation level disposed between two neighboring linear gradation levels according to motion characteristics of the video signal.

17. The apparatus according to claim 16, further comprising:
a moving picture detector to detect whether the video signal includes a moving picture; and
a motion detector to detect a degree of motion of the video signal.

18. The apparatus according to claim 16, wherein the two neighboring linear gradation levels comprise an upper linear gradation level, a lower linear gradation, and the gradation converter determines an upper virtual gradation level disposed between the upper linear gradation level and the at least one middle gradation level and a lower virtual gradation level disposed between the lower linear gradation level and the at least one middle gradation level.

19. The apparatus according to claim 18, wherein the gradation converter further comprises:
a first gradation compensator to perform a first dithering on the video signal; and
a second gradation compensator to perform a second dithering on the video signal.

20. The apparatus according to claim 19, wherein the first dithering approximates the gradation level of the video signal to one of the upper virtual gradation level and the lower virtual gradation level when the gradation level of the video signal is between the upper virtual gradation level and the lower virtual gradation level.

21. The apparatus according to claim 19, wherein the second dithering approximates a gradation level of the video signal corresponding to the upper virtual gradation level to one of the upper linear gradation level and the middle gradation level and approximates a gradation level of the video signal corresponding to the lower virtual gradation level to one of the lower linear gradation level and the middle gradation level according to the motion characteristics of the video signal.

22. The apparatus according to claim 16, wherein the gradation converter approximates the moving picture gradation as one of the two neighboring linear gradation more often than the at least one middle gradation.

23. The apparatus according to claim 16, wherein the at least one middle gradation level comprises a plurality of middle gradation levels disposed between the two neighboring linear gradation levels.

24. The apparatus according to claim 23, wherein the gradation converter approximates a gradation level of the video signal as a corresponding one of the plurality of middle gradation levels, and the gradation converter performs a dithering to convert the corresponding one of the plurality of middle gradation levels to a surrounding gradation level a predetermined number of displayable gradation levels away according to a degree of motion of the video signal.

25. The apparatus according to claim 24, wherein the gradation converter converts the corresponding one of the plurality of middle gradation levels to an adjacent gradation level when the degree of motion is a slow motion, converts the corresponding one of the plurality of middle gradation levels to a gradation level one displayable gradation level away when the degree of motion is a fast motion, and converts the corresponding one of the plurality of middle gradation levels to a gradation level two displayable gradation levels away when the motion is a faster motion.
